(19) United States
(12) Patent Application Publication
(10) Pub. No.: US 2009/0251450 A1
(43) Pub. Date: Oct. 8, 2009

(54) Liquid crystal display device and liquid crystal display device drive method

(76) Inventors: Asahi Yamato, Itabashi-ku Tokyo (JP); Kiyoshi Nakagawa, Yokohama-shi Kanagawa (JP)

Correspondence Address: HARNESS, DICKEY & PIERCE, P.L.C., P.O. BOX 8910, RESTON, VA, 20195, US

(21) Appl. No.: 11/991,108

(22) PCT Filed: Aug. 29, 2006
(86) PCT No.: PCT/JP2006/316954

§ 371 Date: Feb. 27, 2008

(30) Foreign Application Priority Data
Sep. 1, 2005 (JP) 2005-253999

(51) Int. Cl. G09G 5/00; G09G 3/36

(52) U.S. Cl. 345/211; 345/87

(57) ABSTRACT

In one embodiment of the present application, an area control section receives a command specifying a video image display area or a dynamic image display area in the image data. The area control section stores a data of a previous frame screen in the frame memory only for the part which an overdrive is performed, based on the command. A control section outputs a received image data to a source drive section as it is for the image data being notified as a still image display area. For the image data being notified as a video image display area, the image data is converted based on a data stored in a Look-up Table, and performs the display which improves the response speed of the liquid crystal.

### TECHNICAL FIELD

The present invention relates to a method for driving a liquid crystal display device, and particularly relates to a liquid crystal display device which can improve a response speed in displaying a video image, and a method for driving such a liquid crystal display device.

### BACKGROUND ART

There has been a problem of slowness in response speed with conventional liquid crystal display devices. Specifically, a display gray level in the liquid crystal display device is changed by changing transparency of display pixels by changing an orientation of liquid crystal molecules by changing a voltage applied to a liquid crystal layer. The slow response speed in the liquid crystal display device is caused by the long length of time required to complete the change in orientation of the liquid crystal molecule, compared to the change in the voltage applied to the liquid crystal layer.

Driving time per pixel (writing time) has shortened in the recent liquid crystal display devices with large screens or high definition. As a result, the change in orientation of the liquid crystal molecule cannot follow up with the change of the application voltage. This leads to such a problem that the desired display gray level cannot be attained within the writing time.

As a method for attempting the improvement in the response speed, accentuation of the transition gray level by performing an overdrive is known, as disclosed in Patent Document 1. To attain an object gray level C from an initial gray level A, the overdrive is performed such that a voltage to attain an over gray level B greater than the object gray level C is applied to the liquid crystal for a short period, as illustrated in FIG. 9(a). Thus, a large voltage is applied on the liquid crystal, thereby quickening the change in luminance from the initial gray level A to the object gray level C, as illustrated in FIG. 9(b). This attains a faster response time.

In the overdrive method, the voltage that is actually applied to the liquid crystal, in other words the voltage to attain the over luminance B, is determined by comparing the data of the present frame and the data of the previous frame. Therefore, in the overdrive method at least one frame worth of the data of the previous frame is stored. The voltage applied to the liquid crystal is read out from the LUT (Look-up Table), referring to the result of comparing the data of the present frame and the data of the previous frame.

Moreover, for example, Patent Document 2 discloses a method for increasing the response speed in display by using no gray levels that cause slow response speeds. More specifically, the liquid crystal drive method of Patent Document 2 does not use the gray level causing the response speed from a high gray level (white display) to a half gray level to slow down, in a normaly white method. The voltage applied to the liquid crystal being used to drive the liquid crystal display device is usually described by a gray level—luminance curve as illustrated in FIG. 10.

Furthermore, for example, Patent Document 3 discloses a driving method which removes an influencing component causing after-image, and compensates for the slow response speed of the liquid crystal display panel. This is performed by driving the liquid crystal display panel by using data with a signal process that enhances an image change over time. Furthermore, Patent Document 3 discloses the performing of the aforementioned method only in a video image display area in order to eliminate noise that occurs in a still image display area. In order to do this, the still image display area and the video image display area are distinguished.

Patent Document 1

Japanese Unexamined Patent Publication, Tokukai, No. 2004-78129 (Published on Mar. 11, 2004)

Patent Document 2

Japanese Unexamined Patent Publication, Tokukai, No. 2002-131721 (Published on May 9, 2002)

Patent Document 3

Japanese Unexamined Patent Publication, Tokukaihei, No. 2-153687 (Published on Jun. 13, 1990)

Patent Document 4

Japanese Unexamined Patent Publication, Tokukai, No. 2000-221475 (Published on Aug. 11, 2000)

### DISCLOSURE OF INVENTION

However, the method of Patent Document 1 which performs the overdrive requires storing in the memory the data of the previous frame, of at least one frame worth or more. This causes a problem of an increase in electricity consumption required in accessing the memory.

In addition, Patent Document 2 raises the starting voltage to a predefined voltage in order to avoid using the gray level which causes the response speed to slow down. This narrows the displayable luminance range, and results in a decrease in contrast or luminance.

The aforementioned driving methods aiming to improve the response speed can suppress image blur in displaying the video image, however such effect cannot be attained for displaying the still image. That is, the demand to improve the response speed for displaying the still image is not so high. If the aforementioned driving methods are performed for displaying the still image, the demerits in the displaying quality such as the decrease in contrast or luminance is more significantly recognized.

The present invention is made in consideration of the aforementioned problems, and an object thereof is to realize a liquid crystal display device and a method for driving such a liquid crystal display device, each of which prevents the decrease in display quality in a still image display, and cuts down the increase in electricity consumption caused by accessing the memory.

In order to attain the object, a liquid crystal display device of the present invention is a liquid crystal display device in which such a display drive is performed that, when displaying a screen comprising a video image display area and a still image display area, the display drive in the still image display area is display drive A which is performed by transmitting a gray level signal of an input image data to a source driving section of a display section; and the display drive in at least a part of the video image display area is display drive B which allows liquid crystal to respond at fast response speeds, where the display drive B is performed by transmitting to the source driving section of the display section, a converted gray level signal that allows display in which no application voltage causing a slow response speed of liquid crystal is used, the converted gray level signal being obtained by converting the gray level signal of the input image data.

According to the arrangement, blurring of the video image can be suppressed by performing the display drive B which realizes the fast response speed of the liquid display in at least a part of the video image area. The display drive B which realizes the fast response. speed of the liquid crystal is a driving method performed by transmitting to the source driving section of the display section, a converted gray level signal that allows display in which no application voltage causing a slow response speed of liquid crystal is used, the converted gray level signal being obtained by converting the gray level signal of the input image data.

The aforementioned driving method has the merit that blurring of the video image can be suppressed in the video image area, however also has the demerit that the luminance or contrast decreases if being used in the still image area. However, the malfunction such as the decrease in luminance or contrast can be avoided by performing display in the still image display area by transmitting the gray level signal of the input image data to the source driving section of the display section.

Specifically, the arrangement can attain the merit of the suppression of video blurring in the video image area, without the occurrence of malfunctioning such as the decrease in luminance or contract in the still image area, whereby good display quality is maintained.

### BRIEF DESCRIPTION OF DRAWINGS

FIG. 1 illustrates one embodiment of a method for driving the liquid crystal display device of the present invention, and is a characteristic view showing relationship of gray level and luminance in video image display in which low gray level area is cut off.

FIG. 2 is a block diagram illustrating a whole arrangement of the liquid crystal display device.

FIG. 3 is a waveform chart illustrating a response waveform in video image display of the liquid crystal display device in which the low gray level area is cut off and overdrive is carried out.

FIG. 4(a) is a view illustrating relationship of a gray level data written on a pixel and the time in overdrive for changing the gray level of the pixel from gray level 0 (black) in a previous frame to a gray level 128 (half gray level) in a present frame.

FIG. 4(b) is a waveform chart illustrating a response waveform of a liquid crystal. The response waveform is attained by FIG. 4(a).

FIG. 5 is a view illustrating a Look-up Table in which output data of the overdrive is stored. The output data is associated with gray levels of the video data of the previous frame and the gray levels of the video data of the present frame in the liquid crystal display device.

FIG. 6 is a characteristic view illustrating relationship of the gray level and the luminance in video image display of the liquid crystal display device in which an n gray level is allotted into (n-m) or in which the same application voltage range is re-allotted to n number of gray levels.

FIG. 7 is a view illustrating a screen arrangement including a still image display area and a video image display area.

FIG. 8 is a view illustrating a displaying process in the video image display area, in a Second Embodiment.

FIG. 9(a) is a waveform chart illustrating overdrive in a conventional liquid crystal display device drive method.

FIG. 9(b) is a view illustrating how luminance is changed in overdrive, in the conventional liquid crystal display device drive method.

FIG. 10 is a characteristic view illustrating usual relationship of the gray level and the luminance in the liquid crystal display device.

### BEST MODE FOR CARRYING OUT THE INVENTION

### First Embodiment

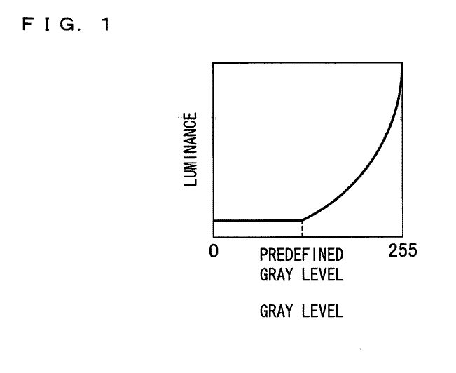

One embodiment of the present invention is described below with reference to FIGS. 1 through 7.

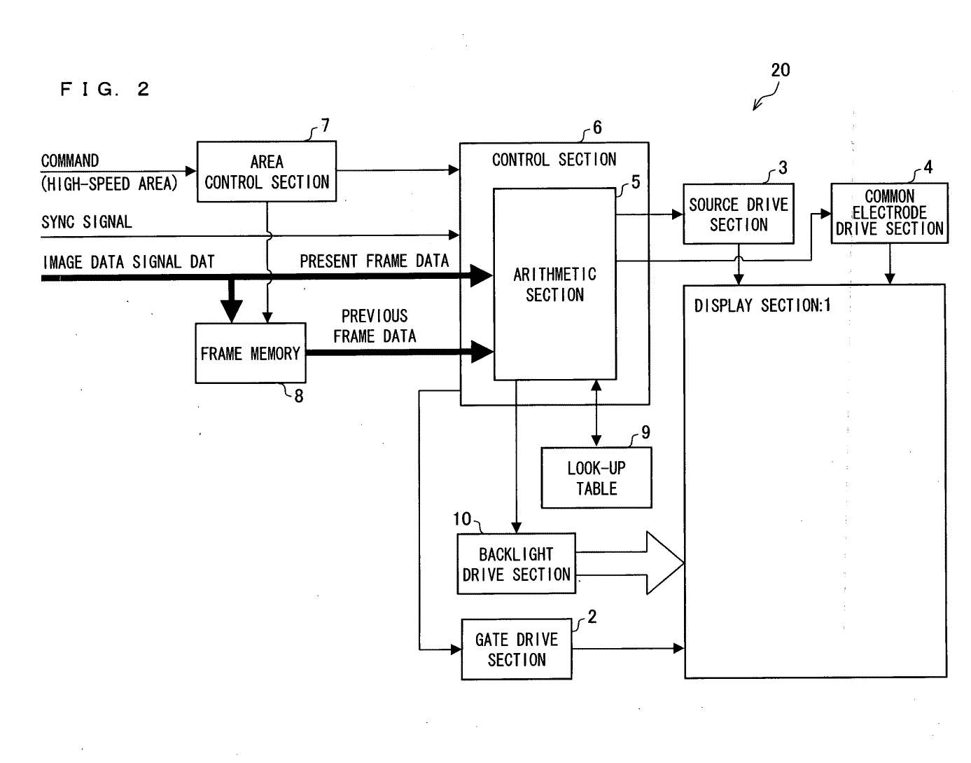

A liquid crystal display device 20 of the present embodiment (for example of an active-matrix type) includes a display section 1, a gate drive section 2, a source drive section 3, a common electrode drive section 4, a control section 6 having an arithmetic section 5, an area control section 7, a frame memory 8, a Look-up Table 9, and a backlight drive section 10, as illustrated in FIG. 2.

The display section 1 has e number of scanning lines parallel to each other and f number of data signal lines parallel to each other, and pixels are arranged in a matrix form. The pixels are arranged in areas surrounded by two adjacent scanning lines and two adjacent data signal lines. Detailed explanation on the display section 1 is omitted here.

Based on a gate clock signal or a gate start pulse being outputted from the control section 6, the gate drive section 2 consecutively generates scanning signals that are to be passed to the scanning signal line connected to the pixels of each row.

The source drive section 3 samples an image data signal DAT according to a source clock signal and a source start pulse being outputted from the control section 6, and outputs the obtained image data to the data signal line connected to the pixels in each column.

The control section 6 is a circuit which creates and outputs various control signals for controlling the operation of the gate drive section 2 and source drive section 3. The control signals are created based on an inputted sync signal, the image data signal DAT or a video/still image indication signal MS. The control signals being outputted from the control section 6 are signals such as various clock signals, various start pulse, and the image data signal DAT as aforementioned.

In order to perform the video image display, the arithmetic section 5 of the control section 6 converts the image data signal DAT. Data conversion by the arithmetic section 5 is performed based on for example the data stored in the Look-up Table 9. The arithmetic section 5 may be integrated with a driver such as the source drive section 3, gate drive section 2 or the like. Further, the arithmetic section 5 may be a part of an exterior control IC in the case the liquid crystal display device is equipped with the exterior control IC. The arithmetic section 5 may be provided inside the display section 1 as a monolithic circuit. The arithmetic section 5 is provided inside the control section 6 in the above example, however the present invention is not limited to this, and may be arranged such that the arithmetic section 5 is provided in the upstream of the control section 6, and can perform a gray level process or a black process.

Each pixel in the display section 1 includes such as a switching element for example a TFT (Thin Film Transistor) and a liquid crystal capacitor. In such pixels, the TFT gate is connected to the scanning signal line, the data signal line is connected to one electrode of the liquid crystal capacitor via the TFT drain and source, and the other electrode of the liquid crystal capacitor is connected to a common electrode line shared with all pixels. The common electrode drive section 4 supplies the voltage that is to be applied to the common electrode line.

The liquid crystal display device 20 is arranged such that the gate drive section 2 selects a scanning signal line, and the image data signal DAT for the pixel corresponding to the combination of the selected scanning signal line and the data signal line is outputted to the respective data signal line by the source drive section 3. Thus, the image data is written to the pixels connected to the scanning signal line. Similarly, the gate drive section 2 consecutively selects each respective scanning signal line, and the source drive section 3 outputs the image data to the data signal line. All pixels in the display section 1 have an image data written in as a result, and the image corresponding to the image data signal DAT is displayed on the display section 1.

The image data sent from the control section 6 to the source drive section 3 is transmitted in a time-division manner as the image data signal DAT. When the image data is sent via the control section 6 to the source driving section 3, the present frame data is stored in the frame memory 8. The stored one frame worth of frame data in the frame memory 8 is used to compare the frame data with the previous frame data when the arithmetic section 5 overdrives.

The source drive section 3 extracts each image data from the image data signal DAT and transmits this to the respective pixel, at the timing indicated by the source clock signal being a timing signal, the inverted source clock signal, and the source start pulse.

The liquid crystal display device 20 according to the First Embodiment performs display involving a high-speed process in the video image display area, in order to suppress the blurring in the video image by improving the response speed. That is, the response speed is improved by performing the high-speed process, which is to perform display by using no levels that cause the slow response speed of the liquid crystal.

In detail, for example, assume the response of the application voltage in a range of V0 to V31 being correspondent to the gray level in a range of 0 to 31 is particularly slow in a normaly black method, given the whole number of gray levels is 256 gray level. The 32 gray levels with the application voltage in the range of V0 to V31 in this case are raised in voltage to have the same voltage as the application voltage V32 being correspondent to gray level 32 (predefined gray level). As a result, the relationship of the gray level and the luminance becomes what is illustrated in FIG. 1.

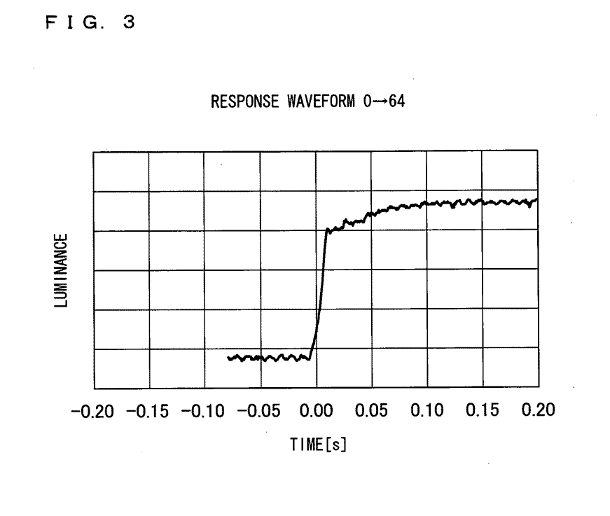

In addition, the display involving the high-speed process according to the First Embodiment can excellently improve the response speed in displaying video image by performing the overdrive, as illustrated in FIG. 3. The gamma characteristic of the display section 1 does not change if the application voltage for the other gray levels (in a range of V32 to V255) are not changed. Thus, it is also possible to maintain a good display in this case.

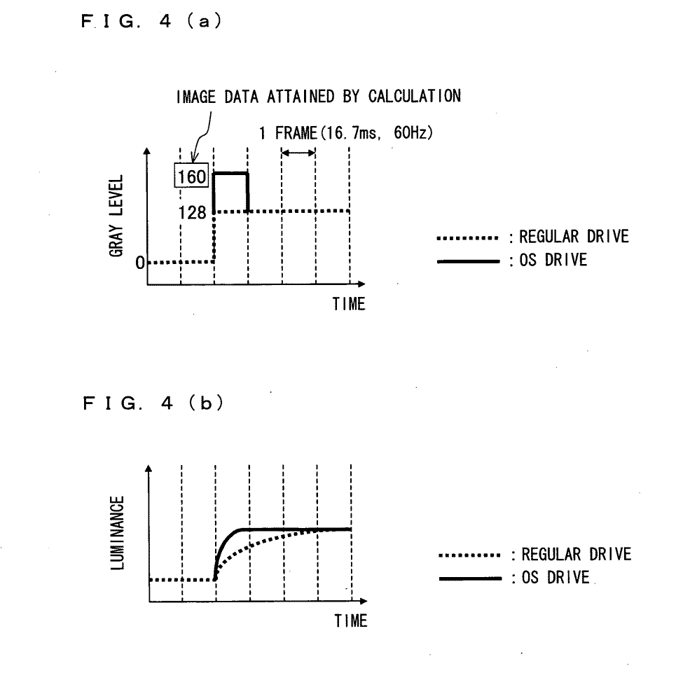

The following is an explanation of the overdrive. The overdrive is a driving method in which the data of the present frame is compared with the data of the previous frame, the data of the present frame is corrected based on the relationship thereof, and the corrected data is applied. “The relationship” is precisely a relationship that ‘a gray level to be applied is different from the gray level of the one previous frame (hereafter referred as “previous frame”) by a larger extent than a difference between the gray level of the one previous frame and the gray level of the input data of the present frame (hereafter referred as “present frame”)’. For example, given that the gray level of the previous frame is V0 and the gray level of the input data of the present frame is V128, for example a gray level V160 is applied in the overdrive. By applying a gray level of this kind, a liquid crystal response waveform which has a fast rise is attained, as illustrated in FIG. 4(b).

As above, the overdrive is a driving method in which a voltage different to the usual voltage is applied for the one frame immediately after a change in gray level. The amount of change in voltage changes depending on the relationship of the gray level before the change and the gray level after the change. Therefore, change in the luminance of a gray level is not always a certain value.

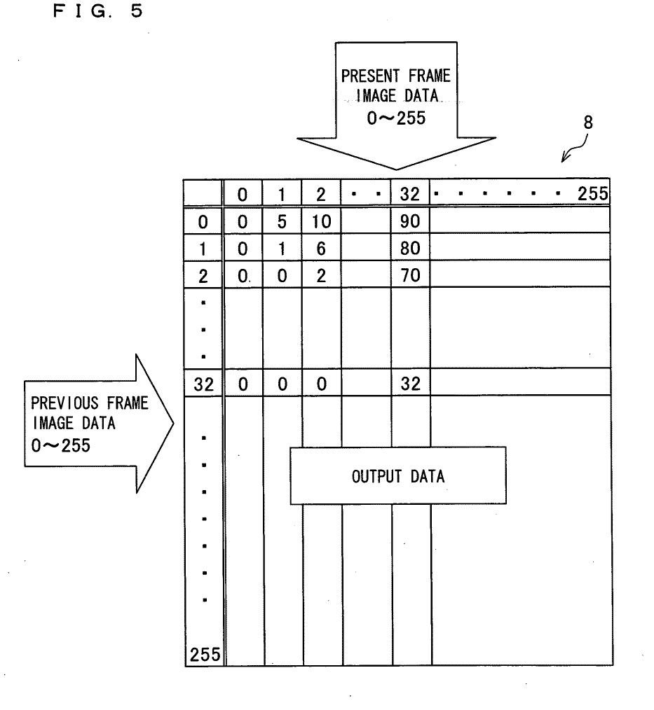

The gray level in order to perform the overdrive may be obtained by calculation. That is, the gray level requiring application of a higher voltage than the usual application voltage for the desired gray level may be calculated from the relationship of the gray level before the change and the gray level after the change. However, the present invention is not limited to this, and may also be worked out by using the Look-up Table 9 as illustrated in FIG. 5.

The luminance-gray level characteristic illustrated in FIG. 1 shows that luminance range being displayable becomes narrower than in when regular display is performed. Thus, display quality becomes poor. Consequently, the luminance-gray level characteristic may be set as follows such that the luminance-gray level characteristic becomes smooth.

More specifically, for example, if the whole number of gray levels is n, and the predefined gray level is m, the n gray level is allotted in the (n-m) gray level voltage.

In detail, the voltage applied for the gray levels under the predefined gray level m (m is an integer of 1 or more) are not used, and the voltage applied for the m gray level to the n-1 gray level is allotted over all n number of gray levels (n is a bigger integer than m). Then, when the allotted voltage for the k (k is an integer in a range of 0 to n) gray level is applied, the overdrive which applies a higher voltage than the usual voltage applied for the k gray level is performed.

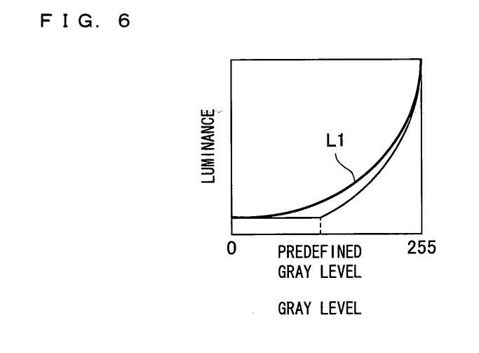

Thus, a luminance-gray level curved line L1 illustrated in FIG. 6 is attained. This luminance-gray level curved line L1 covers the area in a range of gray levels 1 to 255, so the display quality improves compared to the conventional liquid crystal display device.

It is also possible to re-allot for example the same application voltage range as above over the n gray levels. Specifically, gray levels under the predefined gray level m (m is an integer 1 or above) are not used, and all the n number of gray levels (n is an integer greater than m) is re-allotted over gray levels of m to n-1. Then, when the allotted voltage for the k (k is an integer in a range of O to n) gray level is applied, the overdrive which applies a higher voltage than the usual voltage applied for the k gray level is performed. This process is more complex compared to the aforementioned process, however can attain a more smoother gray level display.

The above explanation is based on the normaly black method, however the present invention is not limited to this, and may be applied with a normaly white method.

It is known that in the normaly white method, the response speed slows down when the gray level transfers from a high gray level to a lower gray level, and particularly when both gray levels are of a high level. This slowing down in response speed has been a problem in video image display. By performing display without using the level that causes the slow response speed, it is possible to improve the response speed.

For example, if the response of the gray levels V255 to V241 is particularly slow of all 256 gray levels in the display section 1, the voltage applied to the 15 gray levels is raised to the same voltage as the gray level V240. As a result, the response characteristic significantly improves. The gamma characteristic of the display section 1 does not change if the application voltage for the other gray levels (in a range of V0 to V240) are not changed. As a result, it is also possible to maintain a good display.

As above, the liquid crystal display device 20 according to the present embodiment can improve the responding characteristics by the high-speed process of the display. However, the effect will only appear in the video image display area where the blurring of the video image is suppressed, and no significant effect will particularly appear in the still image area. Therefore, the liquid crystal display device 20 is arranged such that the high-speed process is only performed in the video image display area, and the regular display is performed in the still image display area.

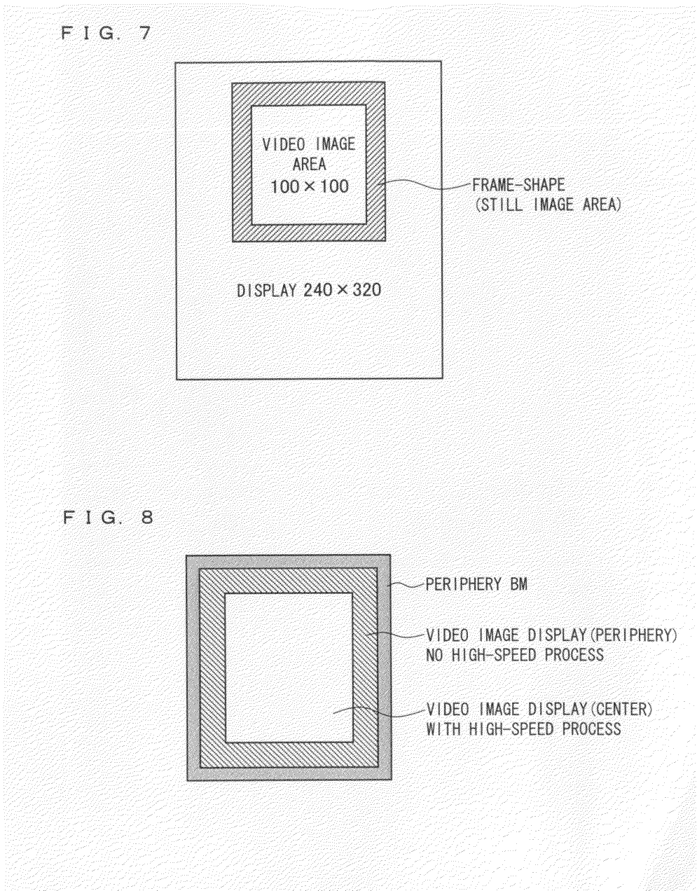

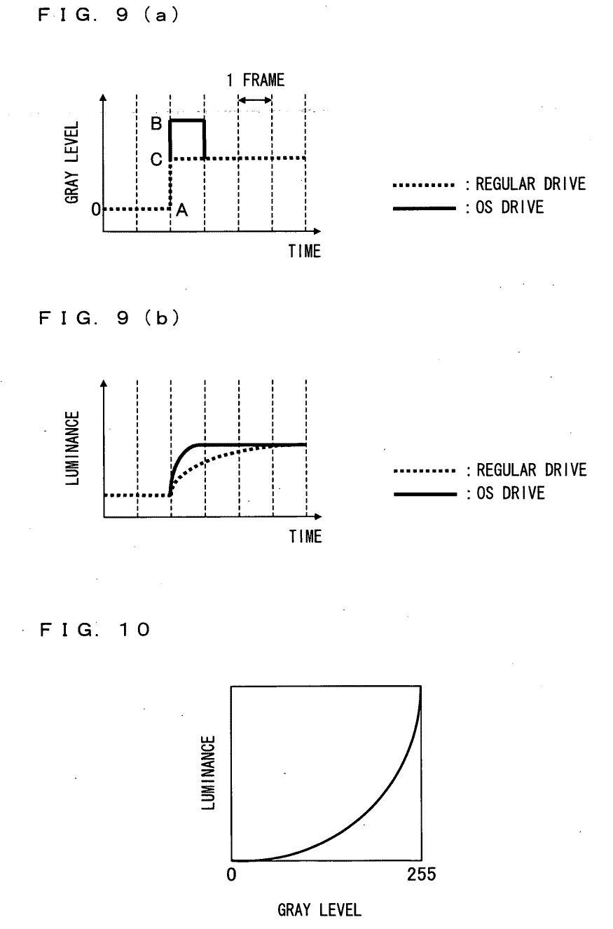

Described below is an explanation of a method for performing different displays in the video image display area and the still image display area. For example, consider a screen arrangement as illustrated in FIG. 7. In this screen arrangement, a frame of a still image display area is drawn, and the area within the frame is the video image display area which displays the video image.

The liquid crystal display device 20 has the area control section 7 provided in the upstream of the control section 6 for performing the high-speed process. That is, the video image display area or the dynamic image display area is specified by a command sent from a supplier of the image data. The command is sent together with the image data. The area control section 7 processes the received command, and passes the area information, that is, the information for specifying the still image display area and the video image display area, to the control section 6 and the frame memory 8.

If it is notified that the image data is for a still image display area, the control section 6 outputs the received image data as it is to the source driving section 3. Specifically, it is possible for the control section 6 to display the still image in the still image display area without the adjustment of the gray level, whereby it is possible to display the still image with no impair in gamma characteristic, luminance or contrast.

On the other hand, conversion of the image data based on the data being stored in the Look-up Table 9 is conducted for the image data notified as image data for a video image display area. This is a process to perform display by using no levels that cause the slow response speed of the liquid crystal.

Furthermore, the control section 6 accesses the frame memory and retrieves the data of the previous frame in order to perform the overdrive. According to a command from the area control section 7, the frame memory 8 stores the data from the previous frame screen for the parts which the overdrive will be performed. The voltage applied for the overdrive is determined for each pixel within the video image display area, by comparing the data of the present frame with the data of the previous frame. The application voltage may be one which is calculated by the control section 6, or may be retrieved from the Look-up Table 9 by referring to the gray level of the present frame and the gray level of the previous frame.

By performing the overdrive only in the video image display area, the amount of electricity consumption can be reduced by reducing the amount of memory access. For example, if the overdrive is performed on the whole screen for a QVGA liquid crystal panel with a data amount of 8 bit per color, the data size becomes 240×320×24 bit=1.8 Mbit. With a frame rate of 60 fps, writing and retrieving is conducted 60 times in one second, thus the amount of the memory access becomes 221 Mbit in one second. In comparison, the arrangement in the present embodiment limits the video image display area to, for example 100×100, therefore the amount of memory access will become 100×100×24×120=29 Mbit/s, which results to a reduction of approximately 200 Mbits/s.

As above, the liquid crystal display device 20 performs display in the dynamic image display area by the regular display driving, and display in the video image display area by the display driving involving the high-speed process. Thus, it is possible to avoid the malfunctioning which occurs when performing the display involving the high-speed process in the still image display area, that is the decrease in the image quality of the still image display area, and the increase in electricity consumption caused by accessing the memory.

The First Embodiment, in order to improve the response of the liquid crystal, performs the process of displaying by using no levels that cause the slow response speed of the liquid crystal as the high-speed process and the process performing overdrive being combined together. However, the high-speed process may be one with the overdrive omitted, and only performing the display by using no levels that cause the slow response speed of the liquid crystal.

### Second Embodiment

A second embodiment of the present invention is described below with reference to FIG. 8.

The liquid crystal display device 20 according to the First Embodiment is arranged such that the display process of the video image display area and the still image display area are different. However, the display would become unnatural (unnaturalness) with the arrangement of the First Embodiment, when switching between the video image and still image in the whole of the display section 1. The cause for this is explained below.

For example, the liquid crystal display device of the normaly black method is slow in response speed around the black gray level. Therefore, if the liquid crystal display device 20 according to the First Embodiment is one of the normaly black method, the black-colored display is converted slightly brighter, when the still image display is switched over to the video image display. This is because the gray level area with the slow response speed will not be used when displaying the video image.

On the other hand, a black matrix (peripheral BM) surrounds the display section 1 of the liquid crystal display device. If a black display (dark display) is displayed on the periphery parts of the display section 1, the black displayed section will be seen in comparison with the black matrix when switching the still image display to the video image display. This causes an unnatural feel for the viewer, since the brightness in the black resulted from the high-speed process of the video image display becomes very noticeable. As such, if the black color is brightened due to the high-speed process, the problem arises such that the effect of the change in black color can be readily seen, particularly around the borderline of the black matrix on the periphery of the display section.

The liquid crystal display device according to the Second Embodiment performs the high-speed process only for the center part of the display section 1, and does not perform the high-speed process on the peripheral parts of the display section 1, as illustrated in FIG. 8. It is arranged as such, in order to solve the unnaturalness occurring when switching between the video image and the still image.

Thus, the liquid crystal display device according to the Second Embodiment can solve the problem of the unnaturalness, by performing a similar display to the still image display on the peripheral parts of the display section 1, without speeding up in the liquid crystal response so that the brightness does not change.

In addition, the First Embodiment performs, as the high-speed process of the liquid crystal, both the processes of displaying by using no levels that cause the slow response speed of the liquid crystal, and the overdrive. However, only the former process causes the unnaturalness occurring when switching between the video image and the still image. Therefore, by only performing the overdrive for the whole of the display section 1, and not performing the process of display by using no levels that cause the slow response speed of the liquid crystal on the peripheral parts of the display section 1, the unnaturalness in the display can be solved.

Even if the video image display is performed on the display section 1, a high-speed video image is not demanded in the peripheral parts as much as the central parts. Therefore, even if the high-speed process is not performed on the peripheral parts of the display section 1, it can be assumed that the demerit in the image quality is small.

By having the area control 7 perform the following process, the performing of the high-speed process in only the central part of the display section 1 while not performing the high-speed process in the peripheral parts thereof can be easily conducted, in displaying the video image in the display section 1. The area control section 7 configures a predefined margin area to be treated as the peripheral parts of the display section 1. This predefined margin area is notified to the control section 6 as the still image display area even for pixels that are recognized as the video image area by the command being sent with the image data.

The control section 6 receiving this margin area information performs the regular display for the peripheral parts of the display section 1 which does not involve the high-speed process, similarly to the still image display area. The amount margin area to configure the peripheral part can be arbitrary set.

As above, a liquid crystal display device of the present invention is a liquid crystal display device in which such a display drive is performed that, when displaying a screen comprising a video image display area and a still image display area, the display drive in the still image display area is display drive A which is performed by transmitting a gray level signal of an input image data to a source driving section of a display section; and the display drive in at least a part of the video image display area is display drive B which allows liquid crystal to respond at fast response speeds, where the display drive B is performed by transmitting to the source driving section of the display section, a converted gray level signal that allows display in which no application voltage causing a slow response speed of liquid crystal is used, the converted gray level signal being obtained by converting the gray level signal of the input image data.

Thus, the blurring of the video image can be suppressed by performing the display drive B which realizes the fast response speed of the liquid crystal in at least a part of the video image area. The display drive B which realizes the fast response of the liquid crystal is a driving method performed by transmitting to the source driving section of the display section, a converted gray level signal that allows display in which no application voltage causing a slow response speed of liquid crystal is used, the converted gray level signal being obtained by converting the gray level signal of the input image data.

The aforementioned driving method has the merit that blurring of the video image can be suppressed in the video image area, however also has the demerit that the luminance or contrast decreases if being used in the still image area. However, this malfunctioning such as the decrease in luminance or contrast can be avoided by performing display in the still image display area by transmitting the gray level signal of the input image data to the source drive section of the display section.

Specifically, the arrangement can attain the merit of the suppression of video blurring in the video image area, without the occurrence of malfunctioning such as the decrease in luminance or contrast in the still image area, whereby good display quality is maintained.

In addition, the liquid crystal display device of the present invention may be arranged such that overdrive is performed for the converted gray level signal in the video image display area in which the display drive B is performed.

By performing the overdrive for the converted gray level signal, the response speed can be improved even better in displaying the video image.

The overdrive requires accessing the frame memory in order to compare the image data of the present frame and the image data of the previous frame. This causes an increase in the amount of electricity consumed. However, the overdrive is not performed in the still image display area, possibly suppressing the increase in electricity consumption at the least.

In addition, the liquid crystal display device of the present invention may be arranged such that the display section has on its periphery part a margin area in which the display drive B is not performed regardless of the video image display or the still image display.

The display drive B (the method which does not use the application voltage in the range the response speed of the liquid crystal is slow) is performed in displaying the video image in the liquid crystal display device, however if this display is performed for the whole of the display section, the display would become unnatural when switching between the video image and the still image.

The above arrangement can solve the unnaturalness by only performing the display drive B in the central section, and not performing the display drive B being the cause for the unnaturalness in the periphery parts of the display section.

In addition, the liquid crystal display device of the present invention may be arranged such that in the margin area, the overdrive is performed for pixels displaying the video image within the margin area.

With the arrangement, the overdrive which does not cause the unnaturalness is performed for the whole of the video image display area, whereby fast response speed of the pixels can be attained.

### INDUSTRIAL APPLICABILITY

The invention can improve image quality in the display area, and also reduce electricity consumption, and is applicable for use in mobile phones, mobile computers and the like.

1. A liquid crystal display device in which such a display drive is performed that:
when displaying a screen comprising a video image display area and a still image display area,
the display drive in the still image display area is display drive A which is performed by transmitting a gray level signal of an input image data to a source driving section of a display section; and
the display drive in at least a part of the video image display area is display drive B which allows liquid crystal to respond at fast response speeds, where the display drive B is performed by converting the gray level signal of the input image data to a gray level signal which does not include a range of an application voltage with a slow response speed of the liquid crystal and then transmitting the converted gray level signal to the source driving section of the display section.

2. The liquid crystal display device as set forth in claim 1, wherein overdrive is performed for the converted gray level signal in the video image display area in which the display drive B is performed.

3. The liquid crystal display device as set forth in claim 1, wherein the display section has on its periphery part a margin area in which the display drive B is not performed regardless of the video image display or the still image display.

4. The liquid crystal display device as set forth in claim 3, wherein in the margin area, the overdrive is performed for pixels displaying the video image within the margin area.

5. A driving method for a liquid crystal display device, the method comprising:
performing display driving, the display driving including:
displaying a screen comprising a video image display area and a still image display area, the step of displaying the screen including:
performing display drive A in the still image display area, where the display drive A is performed by transmitting a gray level signal of an input image data to a source driving section of a display section; and
performing display drive B in at least a part of the video image display area, where the display drive B allows liquid crystal to respond at fast response speeds, and is performed by transmitting to the source driving section of the display section, a converted gray level signal that allows display in which no application voltage causing a slow response speed of liquid crystal is used, the converted gray level signal being obtained by converting the gray level signal of the input image data.

6. The method as set forth in claim 5, wherein overdrive is performed for the converted gray level signal in the video image display area in which the display drive B is performed.

7. The method as set forth in claim 5, wherein the display section has on its periphery part a margin area in which the display drive B is not performed regardless of the video image display or the still image display.

8. The method as set forth in claim 7, wherein in the margin area, the overdrive is performed for pixels displaying the video image within the margin area.
